(19) United States
(12) Patent Application Publication
(10) Pub. No.: US 2001/0032755 A1
(43) Pub. Date: Oct. 25, 2001

(54) Lubrication stystem

(76) Inventor: Gregory J. Prodan, Glendale, AZ (US)

Correspondence Address: Gregory J. Nelson, NELSON & ROEDIGER, Ste. 212, 3333 E. Camelback Rd., Phoenix, AZ, 85018, US

(21) Appl. No.: 09/764,841

(22) Filed: Jan. 17, 2001

Related U.S. Application Data
(60) Provisional application No. 60/176,639, filed on Jan. 18, 2000.

(51) Int. Cl. F16N 11/00

(52) U.S. Cl. 184/84

(57) ABSTRACT

A passive lubrication system for bearings of a kind such as an evaporative cooler. The system has a container having a lid which contains oil. A delivery tube depends into the oil. The tube extends to the lubrication site and preferably one or more coils are formed in the tube. Oil will be slowly drawn through the tube and coils without additional pumping energy being required.

This application is based on prior provisional application No. 60/176,639, filed Jan. 18, 2000, entitled “Lubrication System.”

### FIELD OF THE INVENTION

The present invention relates to a lubrication system and more particularly relates to a lubrication system for oiling bearing of devices such as evaporative coolers which system delivers oil without use of a pump.

### BACKGROUND OF THE INVENTION

Various mechanical devices utilize bearings or journals which require lubrication in order to keep them operating properly. Typical Os such devices are refrigeration equipment and evaporative coolers. These devices have blowers and rotational components which are mounted in bearing which require lubrication, particularly in the harsh, humid and hot environment in which these bearings operate.

Generally such bearings have fittings so that periodic maintenance is required and during such maintenance, the bearings are manually lubricated. However, in some instances these maintenance schedules are not followed. Further location of devices, such as evaporative coolers positioned on roofs or other remote locations, makes them more difficult to access and to properly maintain.

The present invention provides a passive lubrication system for lubricating bearings of equipment such as evaporative coolers and other mechanical devices, particularly where heat or radiant energy is available. There are a number of lubrication devices which can be found in the prior art which are for oiling bearings.

The very early patent to Wearer, U.S. Pat. No. 55,938 dated Jun. 26, 1886, describes an apparatus for oiling bearings. The patent shows a reservoir vessel which contains a lubricant. A pipe extends into the vessel and delivers lubricant to the bearings by means of a siphoning action.

U.S. Pat. No. 407,771 shows a lubricator for shaft bearings having a lubricating cup or reservoir of glass. A tube is bent to form a siphon tube which delivers oil to the bearing. The siphon tube includes a wick so that oil is delivered due to the siphon action as well as capillary action along the wick.

Another siphon lubricating device is shown in U.S. Pat. No. 526,025.

U.S. Pat. No. 1,528,055 shows an oil cup which has a siphon within the cup. The inventor states that when the oil has been heated by reason of heating of the bearings, the pressure in the space above the oil in the cup will be raised to assist in force feeding the oil.

U.S. Pat. No. 4,245,968 discloses a lubricating apparatus having a reservoir for storing oil which is connected to the air inlet area of a control valve to draw oil into the control valve to lubricate the spool of the control valve and the bearings of the pump.

From the above, it appears there are a number of patents in the prior art which show lubricating arrangements which rely on a siphon or a siphon with a wick to deliver oil to lubrication sites. The prior art also recognizes that heating of the oil may enhance the flow of oil in the lubrication site.

Notwithstanding the devices of the prior art as represented by the above patents, there nevertheless exists a need for a simple, effective system for maintaining lubrication to bearings and other mechanical components, which lubricating system is basically passive, requires little or no attention once installed, and does not rely on the operation of pumps or valves to control the flow of lubrication to the lubrication site.

### BRIEF SUMMARY OF THE INVENTION

Briefly, the system of the present invention comprises a container having a reservoir for containment of a suitable lubricant such as an oil having a viscosity of approximately between 20 W to 60 W. One or more lengths of tubing depend into the reservoir. The tubing is coiled at a location above the reservoir and the end of the tubing is directed to a lubrication site such as the lubrication fitting of a bearing. The container and tubing are preferably positioned so as to either receive sunlight or are positioned so that they are heated. Oil will slowly be drawn through the coils and tubing and directed to the bearings and lubrication site. Both the container and coils are heat conductive and the coils are preferably copper tubing. The container may be glass or metal.

### BRIEF DESCRIPTION OF THE DRAWINGS

The above and other objects and advantages of the present invention will be more fully understood and appreciated from the following description and drawings in which:

FIG. 1 is a schematic view showing the lubrication system of the present invention; and

FIG. 2 is detail view of the lubrication system container and delivery line.

### DETAILED DESCRIPTION OF THE DRAWINGS

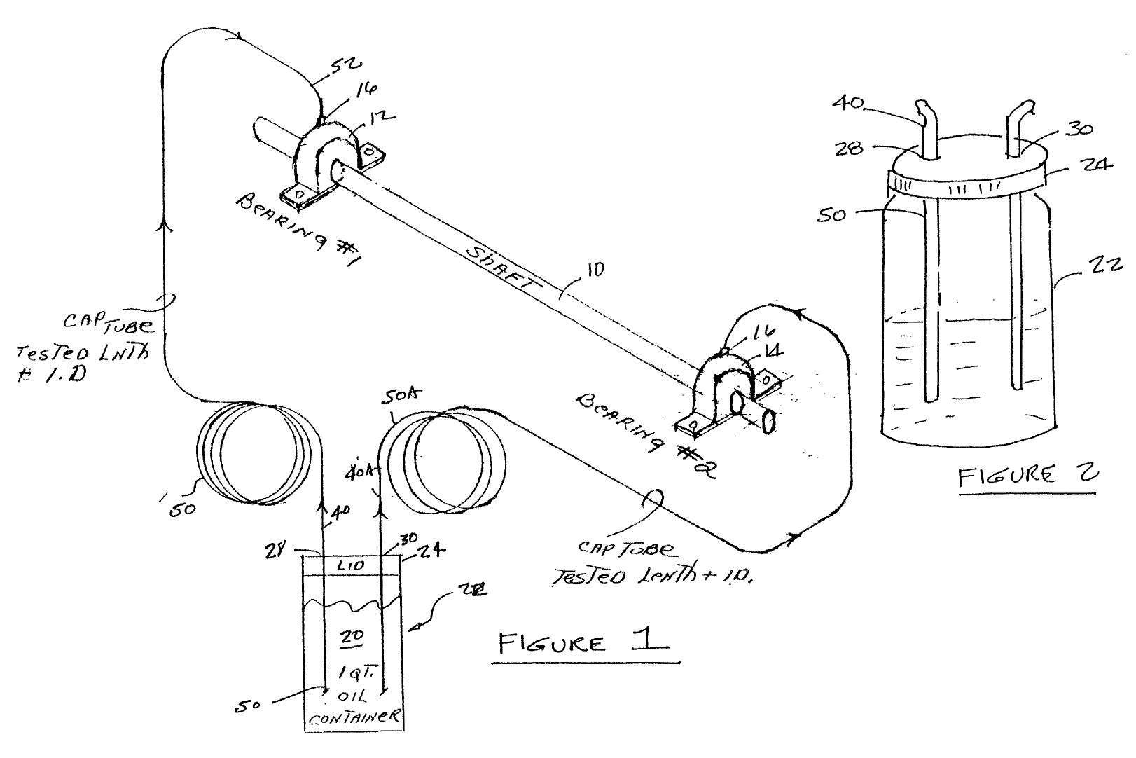

Turning now to the drawings, a representative application of the lubrication system of the present invention is shown. In FIG. 1, a shaft 10 is rotatably supported at opposite ends in bearings 12 and 14. Each of the bearings has a cap or cup 16 which receives a lubricant which is directed to the bearings within the housing. As previously mentioned, the shaft may be a rotating component of various mechanical devices such as the shaft of a squirrel cage blower of an evaporative cooler.

A lubricant, such as oil, is contained within the reservoir 20 of container 22. The oil container 22 may be of various capacities and typically will hold a quart or so of lubricant so refilling is necessary only periodically such as seasonably. The lubricant is preferably a lubricant such as oil having a viscosity in the range of 20 to 60 weight. The container 22 is preferably metal or glass and should conduct heat to the contents within the reservoir. A cap or lid 24 encloses the container. The lid may be a screw-on jar-type lid or may be a snap-on lid having suitable sealing characteristics so as to maintain the contents of the reservoir in a sealed condition and prevent dirt, dust and moisture from entering the container.

The lid of the container defines one or more apertures 28 and 30. Each aperture 28, 30 receives an oil delivery capillary tube 40, 40A respectively. The capillary tubes are preferably copper tubing having an outer diameter of approximately 0.062″ and an inner diameter of approximately 0.005″. Tube 40 has an inlet end 50 which depends through the lid into the oil container. The point of entry of the tubing through the aperture in the lid is preferably sealed.

The tube 40 extends vertically above the lid and at that point each is formed into one or more coils 50, 51, etc. The coils preferably have a coil diameter of approximately 3″ and the copper material allows easy and convenient formation of the coils. The discharge end 52 of tubing section 40 extends from the coils and connects with the cap 16 at the bearings. Preferably the overall length of the copper tubing from the coils to the bearing does not exceed 72″ for best performance. The second tube 40A is similarly formed having coils 50A, 51A and is connected to the opposite bearing 14. Thus multiple lubrication sites can be serviced from a single container.

In use, the container is filled with a suitable lubricant and the lubricant delivery tubes 40, 40A are inserted into the container and are suitably loosely coiled at 50, 50A and then connected to bearings. The container and the delivery tubes, coils are for best performance placed in a position to either receive radiant energy or placed at a location where they are heated due to the operating environment. The oil will slowly pass from the container through the coils and copper tubing by capillary and siphon action and oil will be slowly delivered to a point of use. The system is virtually trouble-free, requires little maintenance and tests have shown that a quart of oil will normally provide lubrication supply to the bearings of an evaporative cooler for many months under normal operation. Preferably the oil container is mounted at a location below the location to be lubricated and a suitable location is the top of a cabinet of an item of equipment such as a housing for an evaporative cooler.

It will be obvious to those skilled in the art to make various changes, alterations and modifications to the invention described herein. To the extend such changes, alterations and modifications do not depart from the spirit and scope of the appended claims, they are intended to be encompassed therein.

I claim:

1. A passive lubrication system for delivering a lubricant to a point of use comprising:
(a) a container having a removable cover and defining a reservoir, said container being of a heat conductive material;
(b) at least one delivery tube depending into said reservoir at a supply end and extending to a delivery location, said tube being coiled at an intermediate location whereby lubricant will be caused to be delivered to said point of use.

2. The lubrication system of claim 1 wherein said tubing is copper tubing.

3. The lubrication system of claim 1 wherein said container is positioned in a location to be heated during normal system operation.

4. The lubrication system of claim 1 wherein said container is positioned below the point of use.

5. The lubrication system of claim 1 wherein said lubrication system lubricates an evaporative cooler.

6. The lubrication system of claim 1 wherein said tube is formed having a plurality of coils.
